(19) United States
(12) Patent Application Publication
(10) Pub. No.: US 2013/0112603 A1
(43) Pub. Date: May 9, 2013

(54) FORWARD OSMOTIC DESALINATION DEVICE USING MEMBRANE DISTILLATION METHOD

(71) Applicants: Sung Mo Koo, Gyeongsangnam-do (KR); Sang Jin Lee, Incheon (KR); Sung Min Shim, Gyeonggi-do (KR)

(72) Inventors: Sung Mo Koo, Gyeongsangnam-do (KR); Sang Jin Lee, Incheon (KR); Sung Min Shim, Gyeonggi-do (KR)

(73) Assignee: STX HEAVY INDUSTRIES CO., LTD., Gyeongsangnam-do (KR)

(21) Appl. No.: 13/643,443

(22) PCT Filed: Apr. 27, 2011
(86) PCT No.: PCT/KR2011/003112

§ 371 Date: Jan. 7, 2013

(30) Foreign Application Priority Data
Apr. 28, 2010 (KR) 10-2010-0039695

(51) Int. Cl. C02F 9/00

(52) U.S. Cl. CPC C02F 9/00
USPC 210/180; 210/258; 210/195.2

(57) ABSTRACT

This invention relates to a fresh water separator including a dilute draw solution chamber, at least one first membrane contactor which receives a fluid fed from the dilute draw solution chamber so that gas and fresh water can be separated from the fluid, a second membrane contactor which enables the separated gas to be dissolved in a fluid flowing in the second membrane contactor so that the separated gas is re-concentrated, and a vacuum pump which cooperates with the first membrane contactor and the second membrane contactor, and to a forward osmotic desalination device including the fresh water separator.

### TECHNICAL FIELD

The present invention relates to a fresh water separator using a membrane distillation method and a forward osmotic desalination device comprising the fresh water separator. More particularly, the present invention relates to a fresh water separator comprising a dilute draw solution chamber, at least one first membrane contactor which receives a fluid fed from the dilute draw solution chamber so that gas and fresh water can be separated from the fluid, a second membrane contactor which enables the separated gas to be dissolved into a fluid flowing in the second membrane contactor so that the separated gas is re-concentrated, and a vacuum pump which cooperates with the first membrane contactor and the second membrane contactor, and to a forward osmotic desalination device.

### BACKGROUND ART

Thorough research into a variety of processes for filtering raw water so that contaminants are removed therefrom thus producing fresh water which is pure has been carried out. In particular, in the case where the raw water is seawater, a device necessary for the above process, called a seawater desalination device, is used to remove not only Cl and Na but also a plurality of inorganic salts.

Desalination devices use distillation, reverse osmosis (RO), crystallization, electrophoresis, forward osmosis (FO), etc. In the case of a forward osmosis process, it has been very limitedly utilized only when a small amount of emergency water is produced in lieu of desalinating a large amount of seawater.

Recently, forward osmosis methods are actively being studied as exemplified by U.S. Pat. Nos. 7,560,029 and 7,566,402. A conventional seawater desalination separator 100 based on forward osmosis as disclosed in the above patents is schematically depicted in FIG. 1.

When solutions having different concentrations are separated from each other by means of a membrane 110 having selective permeability disposed between them, water vapour from the low concentration side passes through the membrane and moves towards the high concentration side in order to maintain the concentration equilibrium of water. This physical phenomenon is referred to as osmosis, and also the pressure generated when a relatively larger amount of water moves towards the higher concentration side is called osmotic pressure.

The process of forward osmosis adopts a semi-permeable membrane in order to separate water from the low-concentration aqueous solution, and requires an osmotic pressure gradient as the driving force for separation, unlike a reverse osmosis process using hydraulic pressure as the driving force. In the forward osmosis process, in order to induce a net flow in which only water contained in feed water passes through the membrane, a draw solution having a relatively higher (about 5˜10 times) concentration than that of the feed water is used.

When osmosis occurs across the membrane 110 using the draw solution, only water in seawater moves towards the draw solution having the high concentration. The seawater is discharged as brine, and the draw solution is diluted and passes through an additional draw solution separator 120. The draw solution separator 120 plays a role in separating fresh water and a draw solute from the diluted draw solution and re-concentrating the separated draw solute so that the re-concentrated solute is fed again to the forward osmosis unit. Such a process is repeated in a system, so that fresh water can be continuously produced.

Typically, a seawater desalination device is problematic in terms of the amount of produced fresh water relative to the amount of introduced energy or chemicals. In particular, in the case of a forward osmotic desalination device, the rate of recovery of the draw solution is directly related to the efficiency problems of the seawater desalination device.

US 2009/0297431 discloses a method for increasing the rate of recovery of the draw solution. This method adopts multiple-state flash distillation (MSF) or multi-effect distillation (MED) to recover the draw solution. However, this method is disadvantageous because a large number of chambers should be used in order to achieve a preferable recovery rate, making it difficult to be realized for actual applications, also because the cost for the facility is high, and the pressure should be additionally controlled, undesirably resulting in complicated processes and the introduction of large amounts of energy.

### DISCLOSURE OF INVENTION

### Technical Problem

Accordingly, the present invention has been made keeping in mind the above problems encountered in the related art, and the present invention is intended to provide a desalination device which may increase the rate of recovery of the draw solution, thus increasing desalination efficiency, namely, the separation/re-concentration efficiency of the draw solution.

In particular, this device may minimize the amount of energy introduced to increase the rate of recovery of the draw solution and may increase the degree of desalination while being easy to install.

The present invention is intended to provide a high-efficiency desalination device which is able to separate a draw solute from any type of raw water including seawater, and which is not only provided as a downstream unit of a forward osmosis unit but also which enables the desalination by itself without the use of the forward osmosis unit.

### Solution to Problem

An aspect of the present invention provides a fresh water separator, comprising a dilute draw solution chamber; at least one first membrane contactor which receives a fluid fed from the dilute draw solution chamber so that gas and fresh water can be separated from the fluid; a second membrane contactor which enables the separated gas to be dissolved in a fluid flowing in the second membrane contactor so that the separated gas is re-concentrated; and a vacuum pump which cooperates with the first membrane contactor and the second membrane contactor.

In this aspect, the first membrane contactor and the second membrane contactor each may comprise a distribution tube which is disposed in the first membrane contactor and the second membrane contactor so that the fluid is able to flow therein and which includes a plurality of openings; and a cartridge comprising a plurality of hollow fiber membranes provided around the distribution tube.

In this aspect, a heating member may be provided to a pipe through which the separated gas flows into the second membrane contactor from the first membrane contactor.

In this aspect, the separated gas fed from the first membrane contactor may pass through a condenser, and the condenser may be provided with a cooling water circulating pipe.

In this aspect, the at least one first membrane contactor may comprise two or more first membrane contactors.

Another aspect of the present invention provides a desalination device, comprising a forward osmosis separator including a membrane; and a fresh water separator which communicates a fluid with the forward osmosis separator, wherein the forward osmosis separator performs forward osmosis so that raw water is fed and discharged as brine on one side of the membrane and a concentrated draw solution is fed and discharged as a dilute draw solution on the other side of the membrane, and the fresh water separator comprises a dilute draw solution chamber into which the dilute draw solution is fed; at least one first membrane contactor which receives the dilute draw solution fed from the dilute draw solution chamber so that gas and fresh water can be separated from the dilute draw solution; a second membrane contactor which enables the separated gas to be dissolved into a fluid flowing in the second membrane contactor thus forming the concentrated draw solution; and a vacuum pump which cooperates with the first membrane contactor and the second membrane contactor.

In this aspect, the first membrane contactor and the second membrane contactor each may comprise a distribution tube which is disposed in the first membrane contactor and the second membrane contactor so that the fluid is able to flow therein and which includes a plurality of openings; and a cartridge comprising a plurality of hollow fiber membranes provided around the distribution tube.

In this aspect, the fresh water separator may further comprise a concentrated draw solution chamber, and the concentrated draw solution chamber may receive the concentrated draw solution fed from the second membrane contactor, and the fed concentrated draw solution may be fed again into the forward osmosis separator from the concentrated draw solution chamber.

In this aspect, the concentrated draw solution chamber may be provided with a cooling water circulating pipe, and a heating member may be provided to a pipe through which the separated gas flows into the second membrane contactor from the first membrane contactor.

As such, the draw solution may be NH₄HCO₃ (l), and the gas may comprise NH₃ (g) and CO₂ (g), and the pipe may be maintained at 60˜80° C. by means of the heating member, and the concentrated draw solution chamber may be maintained at 5˜20° C. by means of the cooling water circulating pipe.

Further, the separated NH₃ (g) and CO₂ (g) fed from the first membrane contactor may pass through the condenser, and the condenser may be provided with the cooling water circulating pipe.

In this aspect, two or more first membrane contactors may be used.

### Advantageous Effects of Invention

According to the present invention, the desalination device can achieve a high rate of recovery of the draw solution, and thus a large amount of fresh water can be produced even when a small amount of energy is used. Furthermore, high desalination efficiency can be attained because of the introduction of a small amount of draw solution.

Thereby, a large amount of fresh water can be produced using low device costs and with small maintenance expenses.

### BRIEF DESCRIPTION OF DRAWINGS

FIG. 1 is a schematic view showing a conventional forward osmotic desalination device;

FIG. 2 is a schematic view showing a desalination device according to an embodiment of the present invention;

FIGS. 3 and 4 are schematic views showing a desalination device according to another embodiment of the present invention; and

FIG. 5 is a perspective view, part of which is depicted in a cross-sectional view, showing a membrane contactor according to the present invention.

### MODE FOR THE INVENTION

The drawings of the present specification omit the depiction of valves, pressure gauges, thermometers, etc., which may be provided on the routes of respective pipes, tanks, chambers and so on. Such valves, pressure gauges, thermometers, etc. may be used according to conventional techniques, and may be appropriately positioned depending on the choice of users.

### Example 1

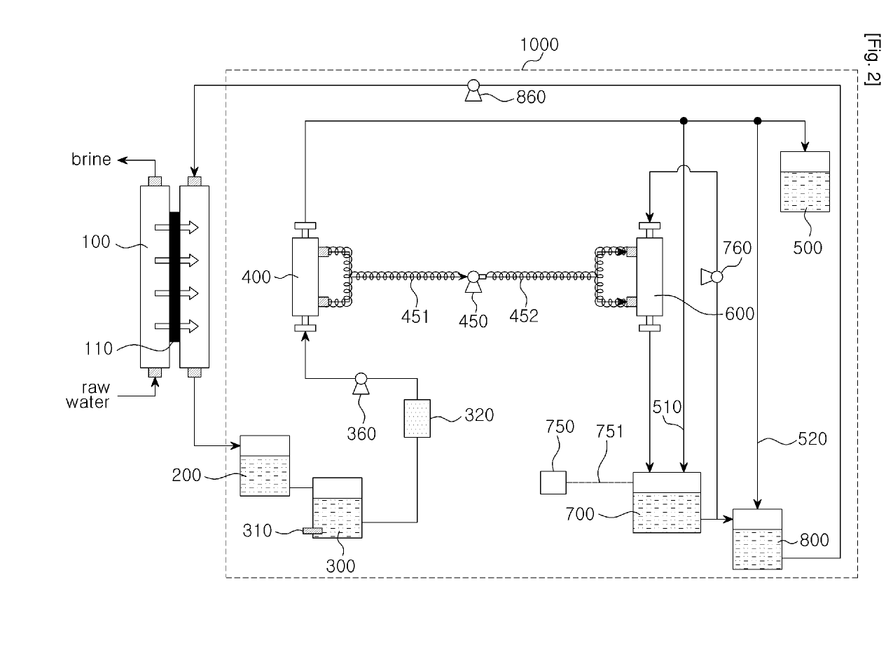

With reference to FIG. 2, a desalination device according to an embodiment of the present invention is described below.

The desalination device includes a forward osmosis separator 100 and a fresh water separator 1000. Alternatively, this device may include only a fresh water separator 1000, without a forward osmosis separator 100, as will be described later.

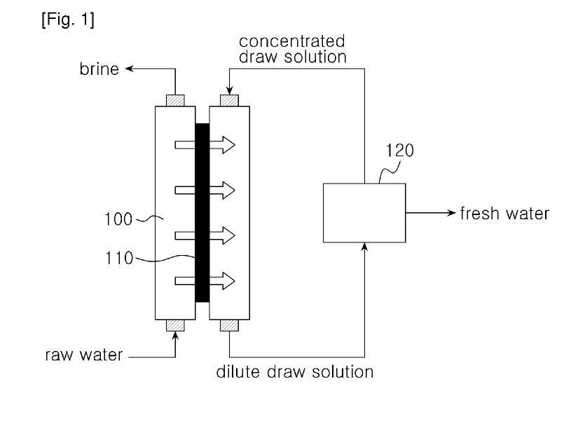

The forward osmosis separator 100 includes a membrane 110 on one side of which raw water is fed and discharged as brine and on the other side of which a concentrated draw solution is fed and discharged as a dilute draw solution. The forward osmotic separation principle of the forward osmosis separator 100 is as described in FIG. 1.

Examples of the raw water which may be fed into one side of the membrane of the forward osmosis separator 100 may include seawater, brackish water, wastewater, contaminated water, and other solutions.

The dilute draw solution which is discharged from the forward osmosis separator 100 is fed into a dilute draw solution chamber 300. In the embodiment of the present invention, the solution may pass through a buffer chamber 200 before entering the dilute draw solution chamber 300.

Also, a heater 310 is connected to the dilute draw solution chamber 300 so that a temperature optimal for separating gas from the draw solution may be maintained.

The dilute draw solution may be fed into a membrane contactor 400 via a filter 320 from the dilute draw solution chamber 300. To this end, the pipe may be provided with a feed pump 360.

The membrane contactor 400 plays a role in separating the gas from the fed draw solution.

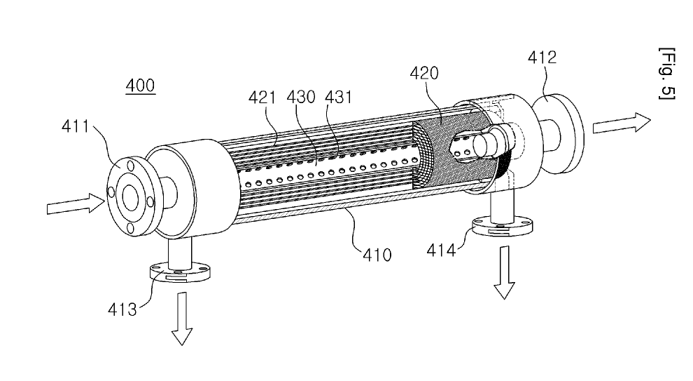

With reference to FIG. 5, the membrane contactor 400 and the separation process thereby will now be specified.

Although this drawing illustrates a hollow type membrane contactor 400, the present invention is not limited thereto and a flat type membrane contactor may be applied. Specifically, it is noted that any type of membrane contactor may be adopted so long as it has the functions described below.

The construction of the membrane contactors 400, 400a, 400b, 600 used in the embodiments of the present invention may be the same. In particular, a reaction that is the reverse of the reaction in the membrane contactor 400 takes place in a membrane contactor 600, a detailed description of which is omitted. For the sake of classification, the membrane contactor 400 for separating the gas and the membrane contactor 600 for dissolving the gas may be referred to as a first membrane contactor and a second membrane contactor, respectively.

The membrane contactor 400 includes a housing 410, an inlet 411 into which the draw solution is fed, an outlet 412 from which fresh water is discharged after the outflow of the gas, and gas outlets 413, 414 from which the gas is discharged.

The housing 410 includes a distribution tube 430 and a cartridge 420 formed therearound.

The distribution tube 430 includes a plurality of openings 431 through which a liquid cannot pass but only a gas can because the membrane is hydrophobic. The distribution tube 430 allows the draw solution which is fed from the inlet 411 to flow therein, and the gas or vapor separated from the draw solution according to Henry's law is fed into the cartridge 420 via the openings 431 from the distribution tube 430 and is then discharged to the outside via the gas outlets 413, 414.

The cartridge 420 is composed of a plurality of hollow fiber membranes 421.

Specifically, a vacuum may be formed in the cartridge 420 by means of the vacuum pump 450 (FIGS. 2˜4). The vacuum pump 450 can be one of the commonly used pump which can create a vacuum. Under such conditions, when the draw solution fed via the inlet 411 passes through the distribution tube 430, the gas is separated from the draw solution according to Henry's law. The separated gas comes out of the draw solution, passes through the openings 431 and the hollow fiber membranes 421, and is finally discharged to the outside of the membrane contactor 400 via the gas outlets 413, 414.

When the gas is discharged from the draw solution, the gas concentration in the draw solution is drastically decreased, and the partial pressure of dissolved gas is adjusted using the temperature and/or the degree of vacuum, so that almost all of the gas is separated from the draw solution, thereby desalinating the draw solution.

The fresh water is discharged to the outside via the outlet 412.

In the case of the membrane contactor 600, the reverse of the above process may be performed, and the fed gas is dissolved in the dilute draw solution thus preparing the concentrated draw solution.

Turning again to FIG. 2, the draw solution is desalinated by the membrane contactor 400 functioning as described above, and thus the fresh water is stored in an additional fresh water tank 500.

The gas separated from the draw solution is fed into the membrane contactor 600 by means of the vacuum pump 450 as mentioned above. In particular, heating members 451, 452 may be provided to the gas pipe in which gas flows. The heating members 451, 452 prevent a formation of solid ammonium (when NH₄HCO₃ (l) is used as the draw solution) as a result of decreasing the temperature of the gas which flows into the membrane contactor 600. The specified temperature and principle are described below.

Although the use of a hot wire heater as the heating members 451, 452 is illustrated in FIG. 2, any type of heating member, other than the hot wire heater, may be used so long as it can heat the pipe.

Furthermore, water or a dilute draw solution is contained in a predetermined amount in a concentrated draw solution chamber 700 at an initial stage, and may be fed into the membrane contactor 600 by means of a feed pump 760. On the other hand, the separated gas may be fed into the membrane contactor 600 from the membrane contactor 400, and thus the gas may be dissolved in water fed into the membrane contactor 600 through a reaction that is the reverse of the reaction described with regard to FIG. 5, thus reproducing the concentrated draw solution. The concentrated draw solution is fed again into the concentrated draw solution chamber 700.

Meanwhile, the fresh water may be fed into the concentrated draw solution chamber 700 via an additional pipe 510. The concentration of the draw solution may be controlled to an appropriate level as desired by a user using the concentrated draw solution fed from the membrane contactor 600 and the fresh water fed via the pipe 510.

Also, a cooler 750 is connected to the concentrated draw solution chamber 700 by means of a cooling water circulating pipe 751, so that the temperature conditions at which the gas in the draw solution is dissolved may be maintained.

In the embodiment of the present invention, the concentrated draw solution chamber 700 may be connected to a storage chamber 800. The storage chamber 800 receives the fresh water fed via an additional pipe 520, so that the concentration of the draw solution may be additionally controlled.

The concentrated draw solution having the preferable concentration is fed again into the forward osmosis separator 100 by means of a feed pump 860, and thus forward osmotic desalination is repeated.

In the embodiment of the present invention, NH₄HCO₃ (l) may be used as the draw solution. In addition, any other solution may be used as the draw solution.

In the case where NH₄HCO₃ (l) is used as the draw solution, the NH₄HCO₃ (l) solution is divided into NH₃ (g) and CO₂ (g) in a gas phase in the membrane contactor 400. As such, the temperature suitable for dividing NH₄HCO₃ into NH₃, CO₂, and H₂O is about 30˜60° C. When the temperature is reversely set to about 60° C. or less, a solid ammonium begins to be produced. The production of the solid ammonium may decrease the rate of recovery of the draw solution and may severely damage the membrane. Hence, heating members 451, 452 are adopted that prevent such production, so that the pipe is heated to an appropriate temperature, which is preferably set to about 60° C. or higher, and more preferably about 60˜80° C.

According to the same principle in terms of the reverse reaction, the temperature of the concentrated draw solution chamber 700 is preferably set to about 5˜20° C. by means of the cooler 750.

In addition, such a fresh water separator 1000 may by itself exert the function of purifying raw water without using the forward osmosis separator 100. Specifically, raw water may be directly fed into the buffer chamber 200. In the case where the raw water is seawater, it is filtered using a filter 320 and the concentration thereof is controlled by means of the membrane contactors 400, 600. In this case, brine is stored in the fresh water tank 500 and is discharged therefrom. Furthermore, when water vapor that has passed through the membrane is condensed, the fresh water may be easily produced. Also in this case, there is no need to re-concentrate the material separated from raw water, thus obviating the need for the membrane contactor 600.

### Example 2

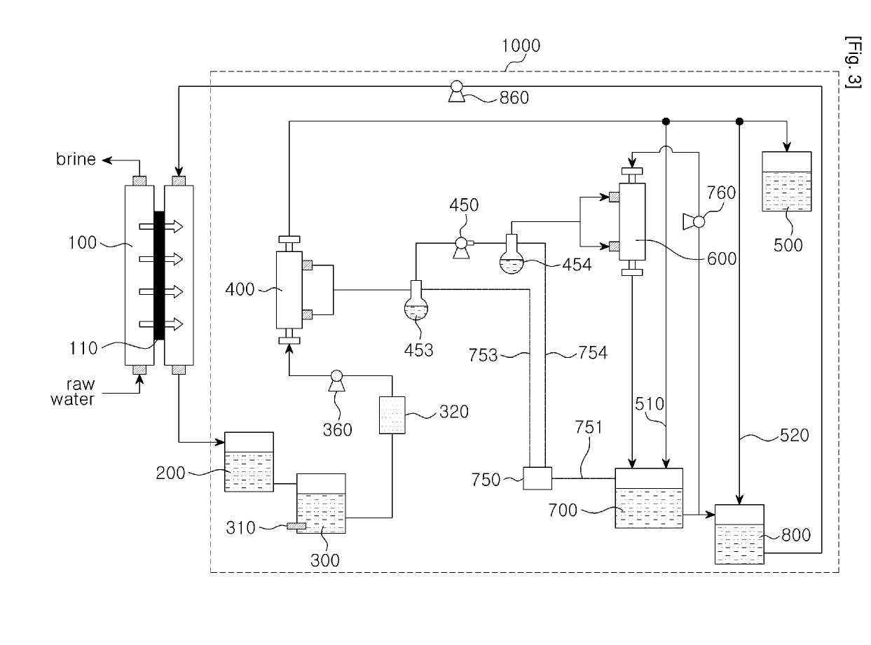

With reference to FIG. 3, a desalination device according to another embodiment of the present invention is described. Compared to the embodiment shown in FIG. 2, the same reference numerals refer to the same elements. The description of the same elements and principle is omitted.

In the embodiment of FIG. 3, condensers 453, 454 are added to remove vapor from the separated gas in order to prevent the reproduction of a solid material (which is an ammonium solid when NH₄HCO₃ (l) is used as the draw solution). When the separated gas is fed into the membrane contactor 600 from the membrane contactor 400 by means of the vacuum pump 450, it may be provided in a state of only the vapor being removed therefrom using the condensers 453, 454.

The condensers 453, 454 are connected to the cooler 750 by means of respective cooling water circulating pipes 753, 754, so that the appropriate temperature is maintained.

### Example 3

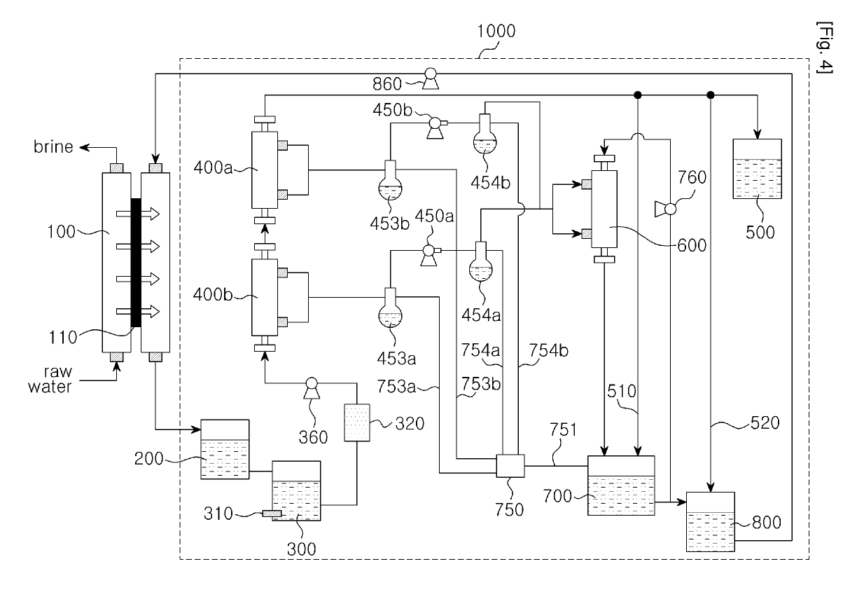

With reference to FIG. 4, a desalination device according to another embodiment of the present invention is described. Compared to the embodiment shown in FIG. 3, the same reference numerals refer to the same elements. The description of the same elements and principle is omitted.

In the embodiment of FIG. 4, two membrane contactors 400a, 400b are adopted so that gas is more efficiently separated thus increasing the degree of desalination. Accordingly, there are provided two vacuum pumps 450a, 450b, two pairs of condensers 453a, 453b, 454a, 454b, and two pairs of cooling water circulating pipes 753a, 753b, 754a, 754b, which respectively correspond to the two membrane contactors 400a, 400b.

As such, the plurality of membrane contactors may be connected in series, in parallel, or in a combination thereof. Taking into consideration the capacity of the membranes, only one vacuum pump or two or more vacuum pumps may be used, and the number of such pumps is not limited.

As mentioned above, the gas is separated and the fresh water is discharged using the membrane contactor 400a. Also, part of the gas may be contained in the fresh water that passed through one membrane contactor 400a, and may be further fed into the additional membrane contactor 400b, thereby increasing the degree of desalination.

According to the same principle, the plurality of membrane contactors, the number of which is two or more, may be used.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A fresh water separator, comprising:
a dilute draw solution chamber;
at least one first membrane contactor configured to receive a first fluid fed from the dilute draw solution chamber separate gas and fresh water from the fluid;
a second membrane contactor configured to enable the separated gas to be dissolved in a second fluid flowing in the second membrane contactor; and
a vacuum pump which cooperates with the first membrane contactor and the second membrane contactor.

2. The fresh water separator of claim 1, wherein:
the first membrane contactor comprises:
a first distribution tube configured to allow the first fluid to flow through the first distribution tube and including a first plurality of openings; and
a first cartridge comprising a first plurality of hollow fiber membranes provided around the first distribution tube;
the second membrane contactor comprises:
a second distribution tube configured to allow the second fluid to flow through the second distribution tube and including a second plurality of openings; and
a second cartridge comprising a second plurality of hollow fiber membranes provided around the second distribution tube.

3. The fresh water separator of claim 1, further comprising:
a pipe through which the separated gas flows into the second membrane contactor from the first membrane contactor; and
a heating member coupled to the pipe.

4. The fresh water separator of claim 1, further comprising a condenser configured to receive and pass through the separated gas from the first membrane contactor, wherein the condenser is provided with a cooling water circulating pipe.

5. The fresh water separator of claim 1, wherein the at least one first membrane contactor comprises two or more first membrane contactors.

6. A desalination device, comprising:
a forward osmosis separator including a membrane; and
a fresh water separator which communicates a dilute draw solution with the forward osmosis separator,
wherein the forward osmosis separator is configured to perform forward osmosis so that raw water is fed and discharged as brine on one side of the membrane and a concentrated draw solution is fed and discharged as the dilute draw solution on the other side of the membrane, and
the fresh water separator comprises:
a dilute draw solution chamber into which the dilute draw solution is fed;
at least one first membrane contactor which receives the dilute draw solution fed from the dilute draw solution chamber so that gas and fresh water are separated from the dilute draw solution;
a second membrane contactor which enables the separated gas to be dissolved in a fluid flowing in the second membrane contactor thus forming the concentrated draw solution; and
a vacuum pump which cooperates with the first membrane contactor and the second membrane contactor.

7. The desalination device of claim 6, wherein:
the first membrane contactor comprises:
a first distribution tube configured to allow the dilute draw solution to flow in the first distribution tube and including a first plurality of openings; and
a first cartridge comprising a first plurality of hollow fiber membranes provided around the first distribution tube and
the second membrane contactor comprises:
a second distribution tube configured to allow the fluid to flow in the second distribution tube and including a second plurality of openings and
a second cartridge comprising a second plurality of hollow fiber membranes provided around the second distribution tube.

8. The desalination device of claim 6, wherein the fresh water separator further comprises a concentrated draw solution chamber, and the concentrated draw solution chamber receives the concentrated draw solution fed from the second membrane contactor, and the fed concentrated draw solution is fed again into the forward osmosis separator from the concentrated draw solution chamber.

9. The desalination device of claim 8, wherein the concentrated draw solution chamber is provided with a cooling water circulating pipe.

10. The desalination device of claim 6, further comprising:
a pipe through which the separated gas flows into the second membrane contactor from the first membrane contactor; and
a heating member coupled to the pipe.

11. The desalination device of claim 9, wherein the draw solution is NH4HCO3 (l), and the gas comprises NH3 (g) and CO2 (g), and the concentrated draw solution chamber is maintained at 5˜20° C. by the cooling water circulating pipe.

12. The desalination device of claim 11, wherein the concentrated draw solution chamber includes a condenser provided with the cooling water circulating pipe, the condenser being configured to receive and pass the separated NH3 (g) and CO2 (g) from the first membrane contactor.

13. The desalination device of claim 6, wherein the at least one first membrane contactor comprises two or more first membrane contactors.

14. The desalination device of claim 11, further comprising:
a pipe through which the separated gas flows into the second membrane contactor from the first membrane contactor; and
a heating member coupled to the pipe, wherein the pipe is maintained at 60˜80° C. by the heating member.
